(19) United States
(12) Patent Application Publication
(10) Pub. No.: US 2025/0178921 A1
(43) Pub. Date: Jun. 5, 2025

(54) METHODS FOR SEEDED PARTICLE GROWTH AND PREPARATION

(71) Applicant: Seer, Inc., Redwood City, CA (US)

(72) Inventors: Frank WALLACE, San Francisco, CA (US); Hongwei XIA, Fremont, CA (US)

(21) Appl. No.: 18/967,457

(22) Filed: Dec. 3, 2024

Related U.S. Application Data
(60) Provisional application No. 63/606,489, filed on Dec. 5, 2023.

(51) Int. Cl. C01G 49/08; C01G 49/06

(52) U.S. Cl. CPC C01G 49/08; C01G 49/06; C01P 2004/62; C01P 2006/42

(57) ABSTRACT

Provided herein are methods of preparing particles, such as nanoparticles, by preparing seed particles and reacting seed particles with one or more reactants to provide one or more particles which are larger in size than the seed particles. The methods provided herein may provide size and size distribution control of particles with enhanced size. Also provided herein are methods of preparing core-shell particles and providing polymer or macromolecule functionalities to said particles.

### CROSS-REFERENCE

This application claims the benefit of U.S. Provisional Patent Application No. 63/606,489, filed, Dec. 5, 2023, which is incorporated herein by reference in its entirety.

### BACKGROUND

Size control of particles can be important in certain applications to allow for particle functionality to be tailored to meet varying requirements. In many instances, intrinsic and extrinsic properties of particles are controlled by their size. While significant research has been done on preparation of particles capable of, for example, renal excretion (e.g., less than 10 nm), there is less understanding on the preparation of larger particles for various other applications, such as for example biomolecule adsorption and isolation or removal from complex biological solutions.

### SUMMARY

Provided herein are methods of preparing (e.g., larger) particles based on seeded growth methods. In some instances, the methods provided herein comprise utilization of seed particles, which are smaller in size, followed by a second reaction with these seed particles to form a larger population of (e.g., nano) particles. In some instances, the methods provided herein allow for size control based on facile tailoring of reaction conditions, such as tailoring of seed particle size and tailoring of reactant amounts while allowing for high yield (e.g., gram scale) yields of metal oxide (e.g., iron oxide) particles (e.g., nanoparticles). The particles can be tailored to optimize pull down efficiency by magnetics, in the case of magnetic particles, to separate them from a supernatant to isolate one or more biomolecules from complex biological solutions.

In some embodiments, provided herein is a method of preparing particles, the method comprising:
(a) preparing seed particles;
(b) providing one or more reactants to a mixture comprising the seed particles; and
(c) reacting the one or more reactants with the seed particles to provide the particles, wherein, the particles have a diameter greater than that of the seed particles, and the particles have a diameter of greater than 200 nm.

In some embodiments, the particles comprise iron oxide particles. In some embodiments, the particles comprise magnetite or maghemite. In some embodiments, the particles comprise superparamagnetic iron oxide.

In some embodiments, the seed particles comprise the same composition as the particles. In some embodiments, the seed particles comprise iron oxide. In some embodiments, the seed particles comprise magnetite or maghemite. In some embodiments, the seed particles comprise a core-shell material. In some embodiments, the seed particles comprise an iron oxide core and a silica shell.

In some embodiments, after (a) the method further comprises washing the seed particles. In some embodiments, washing comprises removing any components other than the seed particles. In some embodiments, washing comprises magnetic isolation.

In some embodiments, the particles comprise a diameter of no greater than 400 nm. In some embodiments, the particles comprise a diameter of about 200 nm to about 400 nm.

In some embodiments, the seed particles comprise a diameter of less than 300 nm. In some embodiments, the seed particles comprise a diameter of less than 200 nm. In some embodiments, the seed particles comprise a diameter of about 10 nm to about 200 nm.

In some embodiments, the particles comprise a polydispersity index (PDI) of less than 0.2 (e.g., less than 0.1). In some embodiments, the seed particles comprise a polydispersity index (PDI) of less than 0.2 (e.g., less than 0.1). In some embodiments, the particles comprise a PDI within 20% of the PDI of the seed particles.

In some embodiments, preparing seed particles comprises reacting one or more first reactants to provide the seed particles. In some embodiments, the first reactants are the same as the reactants. In some embodiments, the reactants comprise the first reactants. In some embodiments, the first reactants and the reactants are provided in the same amount. In some embodiments, the reactants comprise a metal precursor. In some embodiments, the first reactants comprise a metal precursor.

In some embodiments, a mass of the particles increases relative to the ratio of reactants to first reactants. In some embodiments, the diameter of the particles is controllable by modifying the amount of the one or more reactants. In some embodiments, the particles comprise at least 25% more mass relative to the seed particles.

In some embodiments, reacting comprises heating. In some embodiments, reacting comprises heating to no more than 220° C. In some embodiments, preparing seed particles comprises a sol-gel reaction. In some embodiments, reacting the one or more reactants with the seed particles comprises a sol-gel reaction. In some embodiments, the method further comprises (d), forming a (e.g., silica) shell on the particles.

In some embodiments, the particles are nanoparticles or microparticles. In some embodiments, the particles are nanoparticles. In some embodiments, the seed particles are (e.g., seed) nanoparticles.

In some embodiments, the particles are provided as seed particles to repeat steps (a)-(c). In some embodiments, steps (a)-(c) are repeated at least once (e.g., twice, three times, four times, or five times). In some embodiments, the diameter of the particles increases each time steps (a)-(c) are repeated.

Also provided herein, in some embodiments, is a composition comprising a plurality of particles, wherein the particles are obtained by any of the methods provided herein.

In some embodiments, the composition further comprises a biofluid, wherein the particles are dispersed in the biofluid.

In some embodiments, biomolecules are adsorbed onto the particles. In some embodiments, at least 500 unique proteins are adsorbed onto the particles.

### INCORPORATION BY REFERENCE

All publications, patents, and patent applications mentioned in this specification are herein incorporated by reference in their entireties to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1 shows a scheme for preparation of particles herein.

FIG. 2 shows relative mass (normalized to 165 nm iron oxide nanoparticle) vs. mean particle size of particles.

FIG. 3 shows an example of a scanning electron microscopy image of a seed particle prepared according to Example 1.

FIG. 4 shows an example of a scanning electron microscopy image of enlarged particles prepared using seed particles according to Example 2.

FIG. 5 shows an example of a scanning electron microscopy image of enlarged particles with a silica layer prepared according to Example 3.

FIG. 6 shows magnetic pull down efficiency as a function of particle size for particles as described herein as measured at 60 seconds (FIG. 6A) and 100 seconds (FIG. 6B).

### DETAILED DESCRIPTION

### Certain Definitions

As used herein and in the appended claims, the singular forms “a,” “and,” and “the” include plural referents unless the context clearly dictates otherwise. Thus, for example, reference to “an agent” includes a plurality of such agents, and reference to “the cell” includes reference to one or more cells (or to a plurality of cells) and equivalents thereof known to those skilled in the art, and so forth. When ranges are used herein for physical properties, such as molecular weight, or chemical properties, such as chemical formulae, all combinations and subcombinations of ranges and specific embodiments therein are intended to be included. The term “about” when referring to a number or a numerical range means that the number or numerical range referred to is an approximation within experimental variability (or within statistical experimental error), and thus the number or numerical range may vary between 1% and 15% of the stated number or numerical range. The term “comprising” (and related terms such as “comprise” or “comprises” or “having” or “including”) is not intended to exclude that in other certain embodiments, for example, an embodiment of any composition of matter, composition, method, or process, or the like, described herein, may “consist of” or “consist essentially of” the described features.

The term “biomolecule” such as a “biomolecule” in a “biomolecule corona” can refer to any molecule or biological component that can be produced by, or is present in, a biological organism. Non-limiting examples of biomolecules include proteins (protein corona), polypeptides, polysaccharides, a sugar, a lipid, a lipoprotein, a metabolite, an oligonucleotide, a nucleic acid (DNA, RNA, micro RNA, plasmid, single stranded nucleic acid, double stranded nucleic acid), metabolome, as well as small molecules such as primary metabolites, secondary metabolites, and other natural products, or any combination thereof. In some embodiments, the biomolecule is selected from the group of proteins, nucleic acids, lipids, and metabolomes.

### Methods of Preparation

Provided herein are methods of preparing particles (e.g., nanoparticles) of increased size via seeded particle growth. While many applications of nanomaterials are directed to small nanoparticle sizes (e.g., <10 nm) for the purposes of control of biodistribution control, other applications of nanomaterials require increased, but controlled, particle size, with high monodispersity and low levels of aggregation. There is a need for methods of preparing (e.g., nano) particles with high yields via solution (e.g., sol-gel) based methods that achieve higher but monodisperse particle sizes. In some instances, larger particle sizes can be achieved by modifying currently known methods, but reproducibility and yield using these methods is low, lending to the need for alternatives.

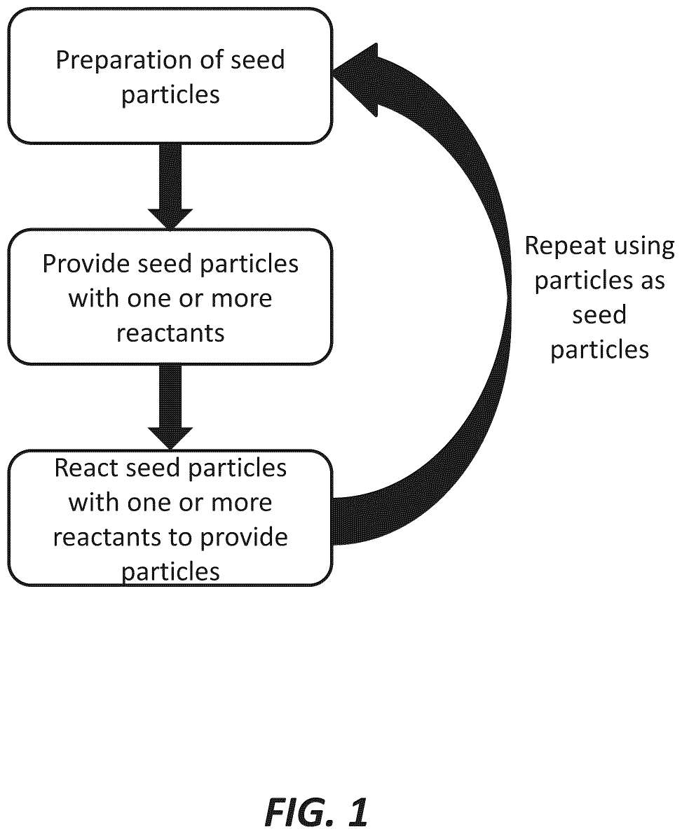

Provided herein are methods of preparing particles. In some instances, the particles provided herein are prepared via seeded growth methods. In some instances, the methods provided herein are described in the scheme provided in FIG. 1. The particles provided by the methods herein may have larger sizes than can be prepared via other methods while also maintaining high levels of monodispersity (e.g., monodispersity of that of the seed particles). The method provided herein may also allow for preparation of larger nanoparticles in yields higher than that would be allowed in traditional sol-gel methods.

In some embodiments, the methods provided herein comprise preparing seed particles. The seed particles provided herein may provide the base on which the one or more reactants, as provided elsewhere herein react to form the one or more particles.

In some embodiments, the seed particles comprise the same composition as the particles. In some embodiments, the seed particles comprise a metal oxide material. In some embodiments, the seed particles comprise a magnetic material. In some embodiments, the seed particles comprise gold, silver, iron, copper, platinum, zinc, or any combination thereof. In some embodiments, the seed particles provided herein comprise alloys. In some embodiments, the seed particles comprise iron oxide. In some embodiments, the seed particles comprise magnetite or maghemite. In some embodiments, the seed particles comprise magnetite. In some embodiments, the seed particles comprise maghemite. In some embodiments, the seed particles comprise a core-shell material. In some embodiments, the seed particles comprise an iron-oxide core. In some embodiments, the seed particles comprise a silica shell.

In some embodiments, the reactants as provided herein react with the (e.g., silica) shell of the particles.

In some embodiments, the seed particles are prepared according to the methods described in Example 1. In some embodiments, the preparing seed particles comprises reacting one or more first reactants to provide the seed particles. In some embodiments, the first reactants comprise a metal precursor. In some embodiments, the metal precursor comprises the analogous salt of a metal oxide to be formed (e.g., iron (III) chloride to form iron oxide).

In some embodiments, the (e.g., first) reactants comprise a solvent, such as any suitable solvent according to one of skill in the art. In some embodiments, the solvent comprises a glycol. In some embodiments, the solvent is ethylene glycol, propylene glycol, butylene glycol, pentylene glycol, or hexylene glycol. In some embodiments, the solvent is ethylene glycol. In some embodiments, the solvent is provided in any suitable amount, such as any amount necessary to dissolve the one or more first reactants. The amount of the solvent is dependent on the scale of the reaction and can be determined by one of skill in the art guided by the teachings of the present application.

In some embodiments, the (e.g., first) reactants comprise a reducing agent. In some embodiments, any reducing agent suitable for use in the particle synthesis, and in any suitable amount, may be used according to one of skill in the art. In some embodiments, the reducing agent may be sodium citrate, tannic acid, sodium borohydride, or ascorbic acid. In some embodiments, the reducing agent is sodium citrate.

In some embodiments, the (e.g., first) reactants comprise a buffering agent. In some embodiments, the buffering agent comprise any buffering agent suitable according to one of skill in the art, and may be provided in any amount according to one of skill in the art. In some embodiments, the buffering agent is sodium acetate. In some embodiments, the (e.g., concentration of) sodium acetate may act as a structure directive agent for the particles. In some embodiments, the (e.g., concentration of) sodium acetate may affect the morphology of the resulting particles.

In some embodiments, the (e.g., first) reactants comprise a metal salt, such as a transition metal salt. In some embodiments, the first reactants comprise an iron salt. In some embodiments, the first reactants comprise a hydrous or anhydrous form of iron chloride, iron bromide, iron iodide, iron sulfate, iron fumarate, iron nitrate, iron oxide, or iron hydroxide. In some embodiments, the metal (e.g., iron) salt is in a monovalent, divalent, or trivalent form. In some embodiments, the metal salt is a trivalent salt. In some embodiments, the metal salt is iron (III) chloride hexahydrate.

In some embodiments, the (e.g., first) reactants as provided herein further comprise a reagent that stabilizes the (e.g., seed) particles. In some embodiments, the reagent that stabilizes the particles comprises polyvinylpyrrolidone. In some embodiments, the reagent that stabilizes the (e.g., seed) particles is provided in any suitable amount according to one of skill in the art.

In some embodiments, any of the (e.g., first) reactants may be provided in an anhydrous form.

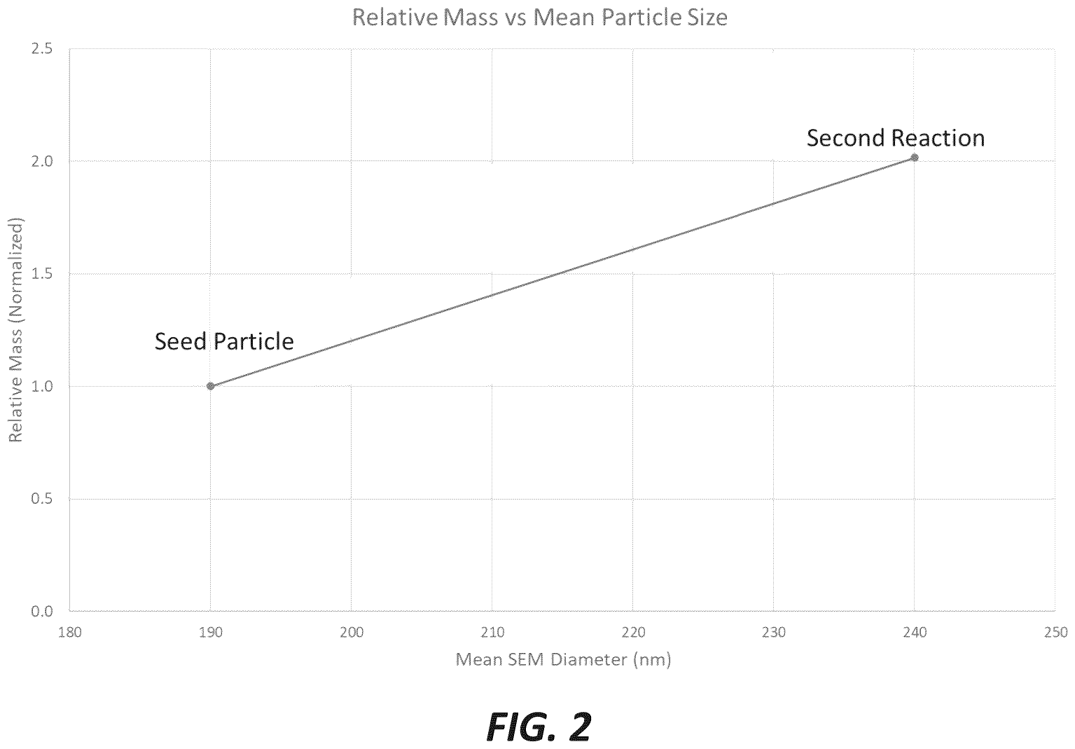

The size of the seed particles provided herein can be measured by any suitable technique, such as dynamic light scattering (DLS), scanning electron microscopy (SEM), or transmission electron microscopy (TEM). In some embodiments, the seed particles herein comprise a diameter that is less than that of the particles (e.g., nanoparticles). In some embodiments, the seed particles provided herein comprise a diameter of no more than 400 nm. In some embodiments, the seed particles provided herein comprise a diameter of no more than 300 nm (e.g., 250 nm, 200 nm, 175 nm, 150 nm, 125 nm, 100 nm, 75 nm, 50 nm, or 25 nm). In some embodiments, the seed particles provided herein comprise a diameter of at least 1 nm (e.g., 5 nm, 10 nm, 20 nm, 30 nm, 50 nm, 75 nm, 100 nm, 125 nm, 150 nm, 175 nm, or 200 nm). In some embodiments, the seed particles provided herein comprise a diameter of about 10 nm to about 200 nm (e.g., about 1 nm to about 300 nm, about 25 nm to about 200 nm, about 50 nm to about 200 nm, about 100 nm to about 200 nm, about 25 nm to about 100 nm, about 50 nm to about 150 nm, about 150 nm to about 200 nm, or about 100 nm to about 300 nm). In some instances, the size (e.g., the diameter) of the seed particle affects the resulting size of the final particles (e.g., nanoparticles), such that larger seed particles may result in larger particles. In some embodiments, seed particles as provided herein comprise a diameter of about 190 nm, such as depicted in FIG. 2. In other embodiments, seed particles may comprise a diameter of about 100 nm to about 250 nm.

In some embodiments, the seed particles comprise a core-shell structure, such as when the seed particle comprises a silica shell. In some embodiments, the particle is comprised of at least 5% of the shell material by weight (e.g., at least 10%, at least 20%, at least 30%, at least 40%, at least 50%). In some embodiments, the particle is comprised of at most 50% (e.g., at most 40%, at most 30%, at most 20%, at most 10%) of the shell material by weight. In some embodiments, the particle is comprised of about 5% to about 10%, about 5% to about 50%, about 10% to about 50%, about 10% to about 40%, about 20% to about 50%, or about 20% to about 30% of the shell material by weight.

In some embodiments, about 20-30 nm of the diameter of the seed particles provided herein is comprised of a shell material as provided elsewhere herein. In some embodiments, at least 2 nm (e.g., 5 nm, 10 nm, 15 nm, 20 nm, 30 nm, 50 nm, 70 nm, 90, nm, or 100 nm) of the diameter of the seed particles provided herein is comprised of a shell material as provided elsewhere herein. In some embodiments, at most 150 nm (e.g., 130 nm, 100 nm, 80 nm, 60 nm, 40 nm, or 20 nm) of the diameter of the seed particles provided herein is comprised of a shell material as provided elsewhere herein. In some embodiments, about 2 nm to about 100 nm, about 2 nm to about 50 nm, about 5 nm to about 100 nm, about 5 nm to about 50 nm, about 10 nm to about 50 nm, about 10 nm to about 20 nm, or about 20 nm to about 30 nm of the diameter of a seed particle provided herein is comprised of a shell material as provided elsewhere herein.

The seed particles can have a homogenous or heterogenous size distribution. In some embodiments, the seed particles have a homogenous size distribution. Polydispersity index (PDI), which can be measured by techniques such as dynamic light scattering, is a measure of the size distribution. A low PDI indicates a more homogeneous size distribution and a higher PDI indicates a more heterogeneous size distribution. In some embodiments, the seed particles provided herein may have a PDI of less than 0.5 (e.g., less than 0.4, less than 0.3, less than 0.2, less than 0.15, less than 0.1, less than 0.05). In specific embodiments, the seed particles provided herein comprise a PDI of less than 0.1. In specific embodiments, the seed particles provided herein comprise a PDI of less than 0.2. In some embodiments, the seed particles comprise a PDI similar to that of the particles (e.g., nanoparticles).

In some embodiments, the methods provided herein comprise (e.g., such as after (a)) washing the seed particles. In some embodiments, washing the seed particles removes any components other than the seed particles (e.g., and any stabilizing moieties) (e.g., from the reaction mixture). In some instances, washing the seed particles removes un-reacted reactants or reaction side products from the reaction mixture. In some embodiments, washing the seed particles comprises magnetic isolation. In some embodiments, magnetic isolation comprises exposing the (e.g., magnetic) seed particles to a magnet which pulls the seed particles down, isolating the seed particles from the supernatant. In some embodiments, magnetic isolation occurs for any suitable period of time to isolate the seed particles from the supernatant. In some embodiments, magnetic isolation occurs for at least 30 seconds (e.g., 1 minute, 2 minutes, 5 minutes, 10 minutes, 15 minutes, or 30 minutes).

In some embodiments, washing as provided herein comprises centrifugation. In some embodiments, centrifugation is completed for any suitable period of time as to separate the (e.g., seed) particles from the supernatant. In some embodiments, centrifugation is completed at any necessary speed to separate the (e.g., seed) particles from the supernatant.

In some embodiments, the methods provided herein comprise providing one or more reactants to a mixture comprising the seed particles.

In some embodiments, the reactants provided to the mixture comprising the seed particles comprise the first reactants as provided elsewhere herein. In some embodiments, the seed particles comprise different reactants than the first reactants as provided elsewhere herein. In some embodiments, the reactants are provided in the same amount as the first reactants. In some embodiments, the reactants are provided in a different amount than the first reactants.

In some instances, the amount of reactants added to the seed particles influences the resulting size (e.g., diameter or mass) of the resulting particles. In some embodiments, the size (e.g., mass or diameter) of the particles is controllable by modifying the amount of one or more reactants. In some embodiments, the size (e.g., mass or diameter) of the particles increases relative to the ratio of first reactants to reactants.

In some embodiments, the methods provided herein further comprise reacting the one or more reactants with the seed particles to provide the particles.

In some embodiments, reacting as provided herein (e.g., such as reacting (e.g., first) reactants to form (e.g., seed) particles) comprises any conditions required to form the (e.g., seed) particles. In some embodiments, reacting comprises a sol-gel reaction. In some instances, preparing seed particles as provided herein comprises a sol-gel reaction. In some embodiments, reacting the one or more reactants with the seed particles comprises a sol-gel reaction.

In some embodiments, reacting comprises heating, such as described in Examples 1 and 2. In some embodiments, reacting comprises heating to no more than 220° C. In some embodiments, reacting comprises heating to no more than 250° C. (e.g., 220° C., 200° C., 180° C., 160° C., 140° C., 120° C., 100° C., or 80° C.). In some embodiments, reacting comprises heating to at least 40° C. (e.g., 60° C., 80° C., 100° C., 120° C., 140° C., 160° C., 180° C., or 200° C.). In specific embodiments, such as described in Examples 1 and 2, reacting comprises heating to about 200° C. In some embodiments, reacting does not comprise heating.

In some embodiments, the particles comprise the same composition as the seed particles. In some embodiments, the particles comprise a different composition than the seed particles. In some embodiments, the seed particles comprise a magnetic material. In some embodiments, the seed particles comprise gold, silver, iron, copper, platinum, zinc, or any combination thereof. In some embodiments, the seed particles provided herein comprise alloys. In some embodiments, the particles comprise a metal oxide material. In some embodiments, the particles comprise a magnetic material. In some embodiments, the particles comprise iron oxide. In some embodiments, the particles comprise magnetite or maghemite. In some embodiments, the particles comprise magnetite. In some embodiments, the particles comprise maghemite.

In some embodiments, the particles are prepared according to the methods described in Example 1, such as by contacting one or more reactants with one or more seed particles.

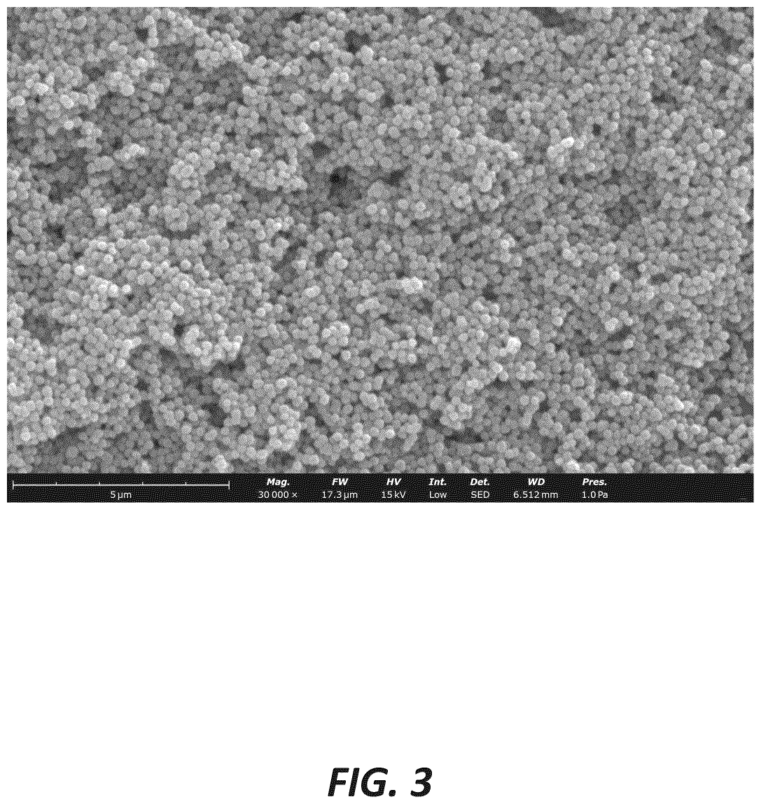

The diameter of the particles as provided herein may be measured according to the methods as provided elsewhere herein (e.g., DLS, SEM, or TEM). In some embodiments, the particles provided herein comprise a diameter of no more than 400 nm. In some embodiments, the particles provided herein comprise a diameter of no more than 1000 nm (e.g., 900 nm, 800 nm, 700 nm, 600 nm, 500 nm, 400 nm, 300 nm). In some embodiments, the particles provided herein comprise a diameter of at least 200 nm (e.g., 225 nm, 250 nm, 300 nm, 350 nm, 400 nm, 450 nm, 500 nm). In some embodiments, the particles provided herein comprise a diameter of about 200 nm to about 400 nm (e.g., about 200 nm to about 1000 nm, about 200 nm to about 800 nm, about 200 nm to about 600 nm about 200 nm to about 500 nm, about 250 nm to about 400 nm, about 250 nm to about 600 nm, about 300 nm to about 600 nm, or about 300 nm to about 800 nm). In specific embodiments, the particles provided herein comprise a size (e.g., diameter) greater than that of the seed particles. In some embodiments, the particles provided herein comprise a diameter in the range of about 150 nm to about 300 nm, such as depicted in FIGS. 3-5.

The particles may, in some embodiments, comprise a core and one or more shells. The core may have, in some embodiments, a diameter of least 200 nm (e.g., 225 nm, 250 nm, 300 nm, 350 nm, 400 nm, 450 nm, 500 nm). In some embodiments, the diameter of the core may be no more than 1000 nm (e.g., 900 nm, 800 nm, 700 nm, 600 nm, 500 nm, 400 nm, 300 nm). In some embodiments, the core may have a diameter of about 200 to about 400 nm. The shell may have, in some embodiments, a thickness of at least 15 nm (e.g., 20 nm, 25 nm, 50 nm, 100 nm, 250 nm). In some embodiments, the particles comprise a superparamagnetic iron oxide core and a silica shell. In some embodiments, the particles have a core comprising, consisting of, or consisting essentially of iron oxide. As a non-limiting example, the particles may have a superparamagnetic iron oxide core with a diameter of about 240 nm, and a silica shell with a thickness of about 25 nm. Additional or different shells may optionally be added to the particles without limitation. For example, a polymer shell may be formed on the silica shell.

In some embodiments, the particles can have a homogenous or heterogenous size distribution. In some embodiments, the particles have a homogenous size distribution. Polydispersity (PDI), which can be measured by techniques such as dynamic light scattering (DLS), is a measure of the size distribution. A low PDI indicates a more homogenous size distribution and a higher PDI indicates a more heterogenous size distribution. In some embodiments, the particles provided herein have a PDI that is similar to the seed particles in which they were formed. In some embodiments, the particles provided herein have a PDI of less than 0.5 (e.g., less than 0.4, less than 0.3, less than 0.2, less than 0.15, less than 0.1, less than 0.5). In specific embodiments, the particles provided herein comprise a PDI of less than 0.2. In specific embodiments, the particles provided herein comprise a PDI of less than 0.1.

In some embodiments, the PDI of the particles provided herein is within 50% of that of the seed particles from which they were formed. In some embodiments, the PDI of the particles provided herein is within 40% (e.g., 30%, 25%, 20%, 15%, 10%, or 5%) of the PDI of the seed particles from which they were formed. In specific embodiments, the PDI of the particles is within 20% of the PDI of the seed particles from which they were formed. In some instances, the particles retain homogeneity upon reaction of the reactants with the (e.g., homogenous) seed particles. In some embodiments, the PDI of the particles provided herein is no more than 50% greater than the PDI of the seed particles. In some embodiments, the PDI of the particles provided herein is no more than 40% (e.g., 30%, 25%, 20%, 15%, 10%, or 5%) greater than the PDI of the seed particles. In some embodiments, the PDI of the particles provided herein is about the same or less than the PDI of the seed particles.

The particles provided herein may be larger than the seed particles. In some instances, the amount at which they are larger than the seed particles is dependent on factors as described elsewhere herein. In some embodiments, the particles provided herein have a diameter that is at least 10% larger than that of the seed particles. In some embodiments, the particles provided herein have a diameter that is at least 15% larger than that of the seed particles (e.g., 17%, 20%, 25%, 30%, 35%, 40%, 45%, or 50%). In some embodiments, the particles provided herein have a diameter that is no more 100% (e.g., 90%, 80%, 70%, 60%, or 50%) larger than the seed particles. In some embodiments, the particles provided herein are about 10% to about 90% (e.g., about 10% to about 70%, about 10% to about 50%, about 10% to about 30%, about 10% to about 20%) larger than the seed particles.

In some embodiments, the particles provided herein have a mass that is larger than that of the seed particles from which they were formed. In some embodiments, the particles have a mass that is at least 1.5× that of the seed particles. In some embodiments, the particles have a mass that is at least 1.5× (e.g., 1.8×, 2×, 2.5×, 3×, 3.5×, 4×, 4.5×, 5×, 5.5×, or 6×) that of the seed particles. In some embodiments, the particles have a mass that is at most 15× (e.g., 13×, 11×, 9×, 8×, 7.5×, or 7×) that of the seed particles. In some embodiments, the particles have a mass that is about 1.5× to about 10× (e.g., 1.5× to about 6×, 1.5× to about 4×, 1.5× to about 3×, 2× to about 10×, 2× to about 5×, 2×, to about 3×, or 3× to about 6×) that of the seed particles. In some embodiments, the particles have mass that is about 2× that of the seed particles.

The size of the particles formed as provided herein may be affected by several factors. In some embodiments, the size of the particles may be affected by the ratio of the first reactants (e.g., to prepare the seed particles) to the reactants (e.g., to make the particles). In some instances, a larger ratio of reactants to first reactants may provide particles of larger size (e.g., diameter and/or mass). In other embodiments, the size of the particles may be affected by the size of the seed particle used. In some embodiments, a smaller seed particle used may provide smaller particles. In other embodiments, a larger seed particle may provide larger particles.

In some instances, such as described in Example 1 and 2, when the same reactants, and same amount of reactants, are used to prepare the seed particles as well as to prepare the particles, the particle mass doubles, while the diameter of the particles increases by about 17%.

In some embodiments, the particle size may be changed by repeating the methods provided herein. In some embodiments, the particles are provided as seed particles to repeat the steps of the method thereby forming (e.g., larger) particles (e.g., a second population of particles). Every instance of repeating the methods provided herein may result in the formation of a further layer of material formed on the surface of the particle, thus increasing diameter and/or mass. In some instances, the methods provided herein can be repeated at least once (e.g., at least twice, three times, four times, five times). In some embodiments, the methods as provided herein can be repeated any number of times necessary to achieve any desired particle size.

In some embodiments, the methods provided herein further comprise an additional step of forming a shell material around the particles (e.g., or seed particles). In some embodiments, the shell material is a silica shell. In some embodiments, the shell material is a metal oxide material (e.g., a different metal oxide than the core material). In some embodiments, the metal oxide material is titanium dioxide. In some instances, the (e.g., silica) shell material is capable of further functionalization for use cases as described elsewhere herein. In some embodiments, the silica shell is further functionalized with an alkoxysilane, such as to install a functional group capable of further functionalization, such as an olefin containing alkoxysilane.

The methods provided herein comprise preparation of particles with tailored size which may affect biomolecule adsorption properties. Particles of increased size (e.g., diameter or mass) may alter biomolecule adsorption properties. In some instances, the size of the particles provided herein affects the rate at which the particles can be removed from solution (e.g., pulled down in solution by a magnet or via centrifugation). Larger particles may be pulled down at a faster rate than smaller particles. Particles with a faster pull-down rate may provide the advantage of allowing for automation (or increased speed of automation) of the uses of the particles as provided herein. The pull-down rate may also be affected by the surface functionalities that may be installed on the surface that are described elsewhere herein, in addition to the size of the particles.

In some embodiments, the particles provided herein are further functionalized with one or more organic functionalities. In some embodiments, the organic functionality is a polymer (e.g., a macromolecule). In some embodiments, the polymer is a block co-polymer. In some embodiments, the polymer is a brush polymer (e.g., a PEG containing brush polymer). In some instances, the organic functionalities provided on the surface of the particles herein affect the interaction of the particle with biomolecules (e.g., such as biomolecules in a biological solution).

In some embodiments, the particles provided herein are further functionalized with one or more macromolecules and/or one or more peptides as described in PCT/US2023/075863, PCT/US2017/067013, PCT/US2019/000061, and PCT/US2024/054605, which are each incorporated herein in their entirety.

In some embodiments, the particles provided herein are further functionalized with (a) a tethering moiety coupled to the (e.g., surface of the) surface and (b) a macromolecule chain as described in International Patent Application No. PCT/US2024/040565, which is incorporated herein by reference in its entirety.

In some embodiments, the particles provided herein are used to form reversible interactions with biomolecules (e.g., proteins). In some embodiments, the particles are contacted with biological solutions to interact with biomolecules (e.g., proteins), preparing biomolecules for analysis.

In some embodiments, analysis comprises mass spectrometry (MS), liquid chromatography-mass spectrometry (LC-MS), protein sequencing, light scattering (e.g., dynamic light scattering (DLS), static light scattering (SLS), or circular dichroism (CD), affinity-based detection methods (e.g., enzyme-linked immunosorbent assay (ELISA), proximity extension assays, or aptamer-based detection) or any combination thereof. In some embodiments, identification or analyzing comprises mass spectrometry, liquid chromatography-mass spectrometry (LC-MS), protein sequencing, or any combination thereof. In some embodiments, identifying or analyzing comprises mass spectrometry. In some embodiments, identifying or analyzing comprises liquid chromatography-mass spectrometry (LC-MS). In some embodiments, identifying or analyzing comprises protein sequencing. In some embodiments, assaying may comprise high throughput single molecule protein sequencing. For example, peptides may be sequenced using TIME DOMAIN SEQUENCING from Quantum-SI. In some embodiments, the analysis comprises targeted mass spectrometry, such as multiple reaction monitoring (MRM). In some embodiments, the analysis comprises top-down mass spectrometry. In some embodiments, the analysis comprises bottom-up mass spectrometry.

In some embodiments, the particles provided herein may be used to identify biomolecules (e.g., proteins) in a biological sample, such as biomolecules provided elsewhere herein. In some embodiments, the method comprise incubating the one or more particles provided herein with a biological sample. In some embodiments, the method comprise forming a biomolecule corona. In some embodiments, the method comprises isolating at least a portion of the biomolecules in the biomolecule corona. In some embodiments, the method comprises assaying the biomolecule corona. In some embodiments, the particles may be incubated with a biofluid (e.g., plasma or serum) such that biomolecules (e.g., proteins) adsorb to the surface of the particles. In some embodiments, at least 500 unique proteins are adsorbed on the surface of the particles.

In some embodiments, the particles provided herein may be used in methods for detecting biomolecule and analyte interactions, such as described in International Patent Application No. PCT/US2023/085783, which is incorporated by reference herein in its entirety.

In some embodiments, the particles (e.g., such as particles comprising organic functionalities) provided herein are used in systems for distinguishing states of a biological system. In some embodiments, the particles (e.g., such as particles comprising organic functionalities) provided herein are used in systems, such as those described in International Patent Application No. PCT/US2020/044908, which is incorporated herein by reference in its entirety.

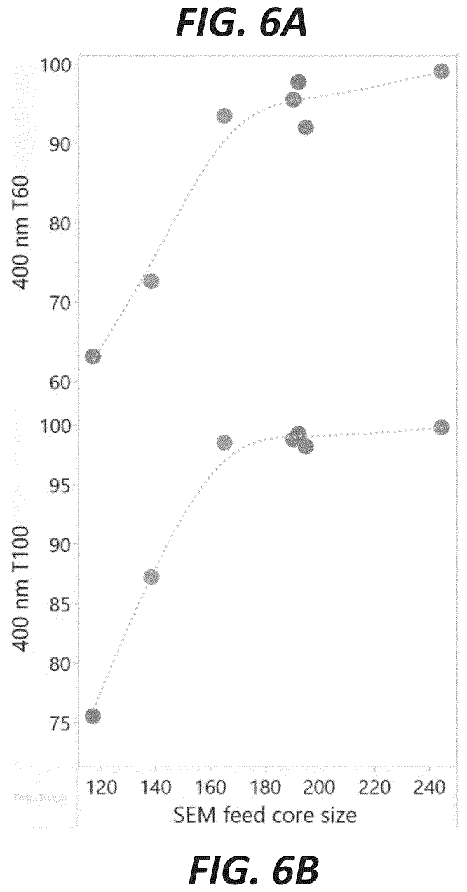

In some instances, size (e.g. mass and/or diameter) of the particles provided herein has an effect on the rate at which particles can be pulled down by a magnet in solution (e.g., pull-down efficiency). In some embodiments, the pull-down efficiency increases as particle size increases. In some embodiments, the pull-down efficiency increases at least until the particles comprise a diameter of about 150 nm. In some instances, this trend is dependent on the surface functionalities that may be installed on the particles (e.g., polymers, macromolecules) as described elsewhere herein. In some embodiments, the pulldown efficiency as a function of particle diameter (e.g., of particles as described herein) is depicted in FIG. 6. In FIG. 6A, % pulldown is depicted as measured at 60 seconds, in FIG. 6B, % pulldown is depicted as measured at 100 seconds. % pulldown was determined using UV-Vis absorbance.

Also provided herein, in some embodiments, are compositions comprising (e.g., a plurality of) particles obtained by any of the methods provided herein. In some instances, provided herein are compositions of a plurality of particles obtained by a seeded growth procedure.

In some embodiments, the particles are dispersed in a medium. In some embodiments, the particles a dispersed in a solvent. In some embodiments, the particles are dispersed in a biofluid (e.g., plasma or serum).

In some embodiments, the composition further comprises a biofluid.

In some embodiments, a biofluid as described herein comprises plasma, serum, urine, cerebrospinal fluid, synovial fluid, tears, saliva, whole blood, milk, nipple aspirate, ductal lavage, vaginal fluid, nasal fluid, ear fluid, gastric fluid, pancreatic fluid, trabecular fluid, lung lavage, sweat, crevicular fluid, semen, prostatic fluid, sputum, fecal matter, bronchial lavage, fluid from swabbings, bronchial aspirants, fluidized solids, fine needle aspiration samples, tissue homogenates, lymphatic fluid, cell culture samples, or any combination thereof.

In some embodiments, biomolecules are adsorbed onto the particles. In some embodiments, a plurality of biomolecules are adsorbed onto the particles. In some embodiments, a plurality of different biomolecules are adsorbed onto the particles. In some embodiments, at least 5, at least 10, at least 20, at least 40, at least 60, at least 80, at least 100, at least 200, at least 400, at least 600, at least 800, at least 1000, or at least 2000 (e.g., different) biomolecules are adsorbed to the particles. In some embodiments, at most 5000, at most 4000, at most 3000, at most 2000, at most 1000, at most 800, at most 600, at most 400, at most 200, at most 100, at most 60, or at most 20 (e.g., different) biomolecules are adsorbed to the particles. In some embodiments, about 5 to about 5000, about 10 to about 2000, about 100 to about 2000, or about 100 to about 1000 (e.g., different) biomolecules are adsorbed to the particles. In some embodiments, the biomolecule is a protein. In some embodiments, at least 500 unique proteins are adsorbed onto the particles.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the invention described herein may be employed in practicing the invention. It is intended that the following claims define the scope of the disclosure and that methods and structures within the scope of these claims and their equivalents be covered thereby.

### EXAMPLES

### Example 1: Preparation of Seed Particles

Seed particles as provided herein are prepared by addition of ethylene glycol (735 g), iron (III) chloride hexahydrate (54.6 g), sodium citrate dihydrate (6.7 g), and sodium acetate (40.4 g) to a reactor. The reaction mixture was heated to 200° C. and allowed to react for 10 hours. After reaction, the mixture was cooled to room temperature and the resulting seed particles were isolated by magnetic separation for 15 minutes and the supernatant was removed. The seed particles were washed by re-suspending in 400 mL of deionized water followed by mixing and sonication for 10 minutes. The seed particles were isolated by magnetic separation (10 minutes) and the supernatant was removed before washing via the same method a second time followed by removal of the supernatant. The resulting seed particles were resuspended in deionized water (300 mL), mixed and sonicated for 10 minutes, and the seed particles were collected, yield: ˜13.6 g. The average particle size of the seed particles was about 190 nm as measured by scanning electron microscopy, as seen in FIG. 3. The polydispersity index (PDI) was measured by dynamic light scattering (DLS) using Malvern Zetasizer Pro-Blue. 4 microliters of test solution containing 5 mg/mL of particles in 0.15 wt % ammonia/deionized water was analyzed at 25° C. after 1 minute of equilibration. The PDI was about 0.12.

### Example 2: Seeded Particle Growth

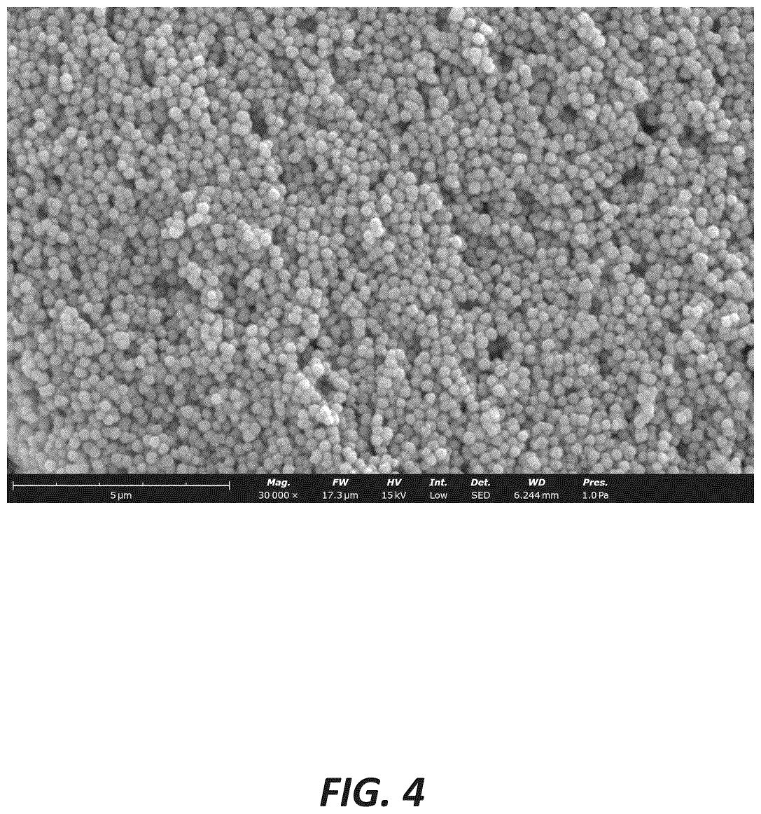

Particles with increased size were prepared by a seeded growth method, as described herein. Seed particles, such as those from Example 1 (13.6 g) were provided in ethylene glycol. To the mixture of seed particles, ethylene glycol (735 g), iron (III) chloride hexahydrate (54.6 g), sodium citrate dihydrate (6.7 g), and sodium acetate (40.4 g) were added to the reactor. The mixture was heated to 200° C. to react for 10 hrs. After reaction, the mixture was cooled to room temperature and the particles were isolated by magnetic isolation (15 minutes) and the supernatant was removed. The particles were washed two times by resuspending the particles in deionized water (400 mL) followed by mixing and sonicating for 10 minutes, followed by magnetic isolation of the particle and removal of the supernatant. Finally, the particles were resuspended in deionized water (300 mL) followed by mixing and sonication (10 minutes) and the particles were collected, yield: ˜27.2 g. The average particle size was measured by scanning electron microscopy to be about 232 nm, as seen in FIG. 4. The polydispersity index (PDI) was measured as described in Example 1 and was about 0.17.

### Example 3: Silica Coating

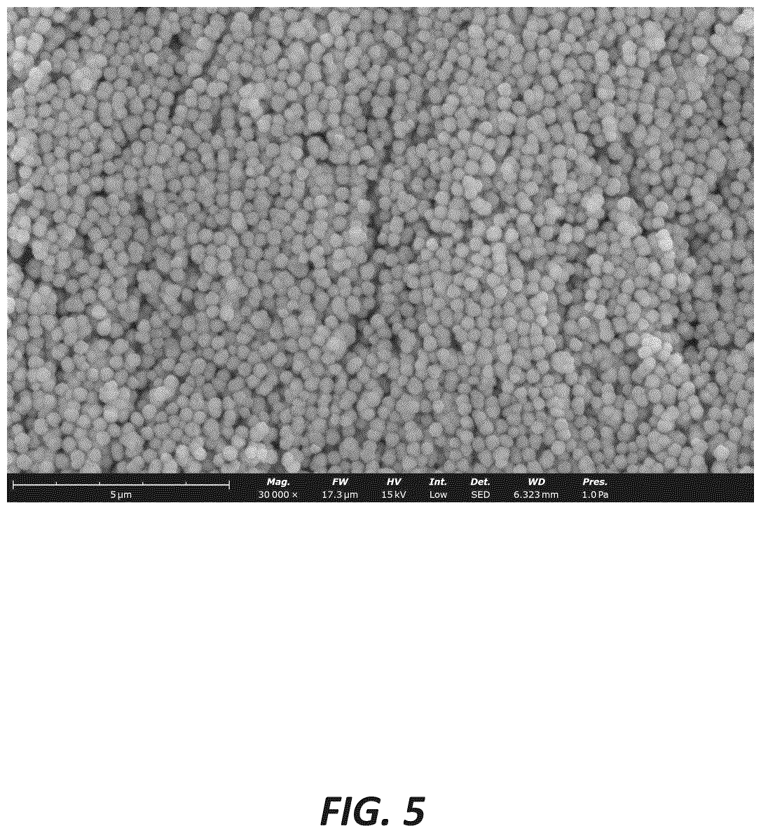

2.88 g of particles (solids basis) from Example 2 were added to a flask. The particles were magnetically isolated and 152 g of ethanol was added, then the mixture was mixed and sonicated to resuspend the solids. 1300 g of ethanol and 28 g of deionized water was added to a 2000 mL round bottom flask to which the particle/ethanol solution was added. This mixture was mixed with an overhead stirrer. 70 g of NH₄OH (28-30% solution) was added. A solution of 30 g of ethanol and 5.6 g of TEOS was prepared, mixed, and added to a syringe. This TEOS/ethanol solution was added to the flask using a syringe pump over 3 hours. The solution was allowed to mix and react for 16 hours at ambient temperature. The particles were washed by resuspending the particles in ethanol (100 mL) once and deionized water (100 mL) twice, followed by mixing and sonicating for 10 minutes, followed by magnetic isolation of the particle and removal of the supernatant. Finally, the particles were resuspended in deionized water (50 mL) followed by mixing and sonication (10 minutes) and the particles were collected, yield: ˜4.4 g. The particle size was measured by scanning electron microscopy to be about 280 nm as seen in FIG. 5. The polydispersity index (PDI) was measured as described in Example 1 and was about 0.1.

1. A method of preparing particles, the method comprising:
(a) providing one or more reactants to a mixture comprising seed particles; and
(b) reacting the one or more reactants with the seed particles to provide the particles,
wherein, the particles have a diameter greater than that of the seed particles, and the particles have a diameter of greater than 200 nm.

2. (canceled)

3. The method of claim 1, wherein the particles comprise magnetite or maghemite.

4. The method of claim 1, wherein the seed particles comprise the same composition as the particles.

5-11. (canceled)

12. The method of claim 1, wherein the particles have an average diameter of no greater than 400 nm.

13. The method of claim 1, wherein the particles have an average diameter of about 200 nm to about 400 nm.

14. The method of claim 1, wherein the seed particles have an average diameter of less than 300 nm.

15. The method of claim 1, wherein the seed particles have an average diameter of less than 200 nm.

16. The method of claim 1, wherein the seed particles have an average diameter of about 10 nm to about 200 nm.

17. The method of claim 1, wherein the particles have a polydispersity index (PDI) of less than 0.2.

18. The method of claim 1, wherein the seed particles have a polydispersity index (PDI) of less than 0.2.

19. The method of claim 1, wherein the particles have a PDI within 20% of the PDI of the seed particles.

20-25. (canceled)

26. The method of claim 1, wherein the particles comprise at least 25% more mass relative to the seed particles.

27. The method of claim 1, wherein the reactants comprise a metal precursor.

28. (canceled)

29. (canceled)

30. The method of claim 1, wherein the reacting comprises heating to no more than 220° C.

31. (canceled)

32. The method of claim 1, wherein reacting the one or more reactants with the seed particles comprises a sol-gel reaction.

33. The method of claim 1, wherein the method further comprises (d), forming a shell on the particles with a shell material, thereby providing core-shell particles.

34. The method of claim 1, wherein the particles are nanoparticles or microparticles.

35. The method of claim 1, wherein the particles are nanoparticles.

36. (canceled)

37. The method of claim 1, wherein the particles are provided as seed particles to repeat steps (a)-(b).

38. The method of claim 37, wherein steps (a)-(b) are repeated at least once.

39-43. (canceled)
